(19) United States
(12) Patent Application Publication
(10) Pub. No.: US 2006/0279745 A1
(43) Pub. Date: Dec. 14, 2006

(54) Color imaging system for locating retroreflectors

(76) Inventors: John Stewart Wenstrand, Menlo Park, CA (US); Julie E. Fouquet, Portola Valley, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/151,475

(22) Filed: Jun. 13, 2005

(51) Int. Cl. G01B 11/14

(52) U.S. Cl. 356/614

(57) ABSTRACT

An imaging system includes an image sensor, a first light source on-axis with the image sensor, and a controller. The image sensor is configured to generate an image of a field of view including a retroreflector. The first light source is configured to illuminate the retroreflector, and the controller is configured to output the image and location data for the retroreflector.

### BACKGROUND

There are many applications in which it is useful to detect or image an object. Detecting an object determines the absence or presence of the object, while imaging an object results in a representation of the object. The object may be imaged or detected in daylight or in darkness, depending on the application.

Wavelength dependent imaging is one technique for imaging or detecting an object, and typically involves capturing one or more particular wavelengths that reflect off, or transmit through, an object. In some applications, solar or ambient illumination is used to detect or image an object, while in other applications additional illumination is used. Typical wavelength dependent imaging systems for detecting objects cannot obtain color images such as conventional photographs for viewing by a user while simultaneously obtaining machine vision-type images in the infrared for detecting objects, such as retroreflectors, using a single image sensor.

### SUMMARY

One aspect of the present invention provides an imaging system. The imaging system includes an image sensor, a first light source on-axis with the image sensor, and a controller. The image sensor is configured to generate an image of a field of view including a retroreflector. The first light source is configured to illuminate the retroreflector, and the controller is configured to output the image and location data for the retroreflector.

### BRIEF DESCRIPTION OF THE DRAWINGS

FIG. 1 is a block diagram illustrating one embodiment of a color imaging system for generating RGB images and retroreflector location data.

FIG. 2 is a block diagram illustrating one embodiment of an imaging system for detecting or locating a retroreflector.

FIG. 3A illustrates one embodiment of an image generated using on-axis illumination.

FIG. 3B illustrates one embodiment of an image generated using off-axis illumination.

FIG. 3C illustrates one embodiment of a difference image resulting from the subtraction of the image generated using off-axis illumination from the image generated using on-axis illumination.

FIG. 4 is a diagram illustrating one embodiment of an image sensor having a patterned filter layer.

FIG. 5 is a diagram illustrating another embodiment of an image sensor having a patterned filter layer.

FIG. 6 is a diagram illustrating another embodiment of an image sensor having a patterned filter layer.

FIG. 7 is a block diagram illustrating another embodiment of an imaging system for detecting or locating a retroreflector.

FIG. 8 is a block diagram illustrating another embodiment of an imaging system for detecting or locating a retroreflector.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

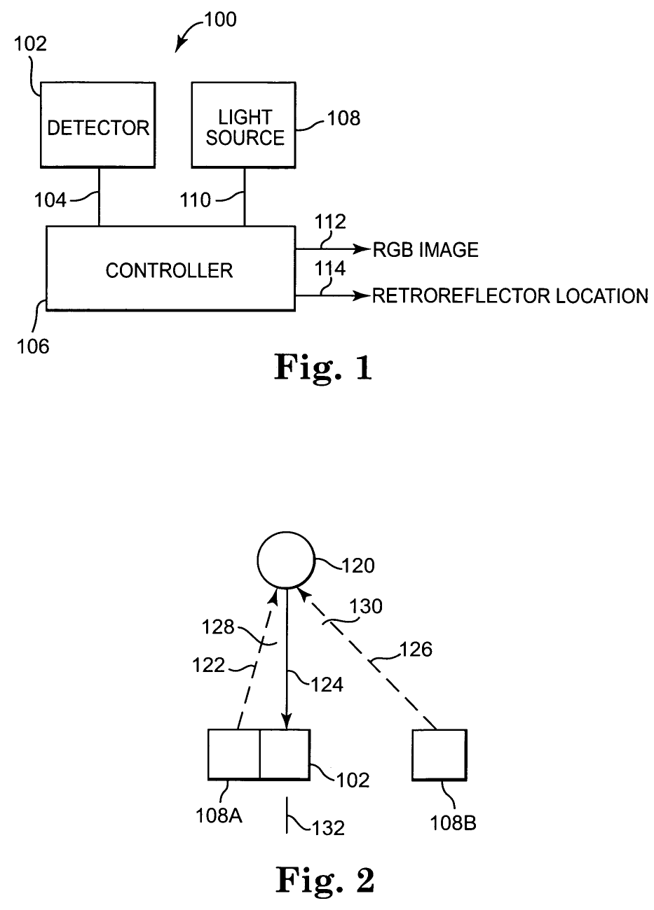

FIG. 1 is a block diagram illustrating one embodiment of a color imaging system 100 for generating red, green, blue, (RGB) images and retroreflector location data. Color imaging system 100 includes detector 102, controller 106, and light source 108. Controller 106 is electrically coupled to detector 102 through communication link 104 and to light source 108 through communication link 110. Controller 106 outputs RGB images on RGB image signal path 112 and retroreflector location data on retroreflector location signal path 114 to a host device (not shown). A retroreflector is a device that reflects light or other radiation back to where it originated regardless of the angle of incidence. One example of a retroreflector is the human eye.

There are a number of applications in which it is useful to determine whether a person's eyes are open or closed, or the location of a person's eyes. One such application is the detection of drowsiness in the operator of a motor vehicle. Another application includes locating the eyes to use as a reference point for facial recognition applications. Applications involving retroreflectors other than a human eye are also numerous, such as security applications and tracking applications.

Imaging system 100 is configured to generate RGB images of the field of view of detector 102 and locate or track retroreflectors within the field of view of detector 102. Imaging system 100 outputs RGB images and data relating to the location of any retroreflectors within the field of view. In one embodiment, imaging system 100 outputs either an RGB image or data relating to the location of a retroreflector based on an image generated by detector 102. In another embodiment, imaging system 100 simultaneously outputs both an RGB image and data relating to the location of the retroreflector based on a single image generated by detector 102.

Detector 102 comprises a color image sensor and lens system for focusing a field of view onto the image sensor to generate an image of the field of view. In one embodiment, the image sensor comprises a complimentary metal-oxide-semiconductor (CMOS) image sensor, a charge-coupled device (CCD) image sensor, or other suitable type of image sensor.

Light source 108 comprises one or more light sources for illuminating the field of view of detector 102. In one embodiment, light source 108 includes a single light source collocated with detector 102 to provide on-axis illumination. In another embodiment, light source 108 includes multiple light sources with at least one light source collocated with detector 102 to provide on-axis illumination and at least one light source not collocated with detector 102 to provide off-axis illumination. In one embodiment, light source 108 includes one or more light emitting diodes (LEDs), white light sources, vertical cavity surface-emitting lasers (VCSELs) with suitable diffusers as needed to widen the angle of illumination, or other suitable light sources.

Controller 106 controls the operation of and receives image data from detector 102 through communication link 104. Controller 106 also controls light source 108 through communication link 110 to turn light source 108 on or off. Controller 106 controls detector 102 to generate images of the field of view of detector 102. Controller 106 outputs RGB images generated by detector 102 on RGB image signal path 112 to a host device (not shown). Controller 106 also analyzes images generated by detector 102 to determine the location of retroreflectors within the images. Controller 106 outputs the location of the retroreflectors on retroreflector location signal path 114. In one embodiment, the retroreflector location data comprise Cartesian coordinates representing image sensor pixels.

FIG. 2 is a block diagram illustrating one embodiment of imaging system 100 for detecting and/or locating a retroreflector 120. In this embodiment, imaging system 100 includes detector 102, a first light source 108A, and a second light source 108B. For clarity of illustration, first light source 108A and second light source 108B are illustrated as being on opposite sides of detector 102. First light source 108A and second light source 108B, however, can be on the same side of detector 102.

First light source 108A illuminates retroreflector 120 with light as indicated generally at 122. Second light source 108B illuminates retroreflector 120 with light as indicated generally at 126. To detect retroreflector 120 according to one embodiment, two images of retroreflector 120 are generated simultaneously by detector 102 using a single image sensor. A first one of the images is generated using illumination from first light source 108A, which is located at a first angle 128 from axis 132 of detector 102. First light source 108A is close to or on axis 132 of detector 102 (on-axis). The second image is generated using illumination from second light source 108B, which is located at a second angle 130 from axis 132 of detector 102. In one embodiment, angle 130 is greater than angle 128. Second light source 108B is spaced apart from axis 132 of detector 102 (off-axis). Retroreflector 120 reflects light back to where it originated. Therefore, retroreflector 120 reflects most of incident light 122 received from first light source 108A back to first light source 108A, with some captured by detector 102, and retroreflector 120 reflects very little of incident light 126 received from second light source 108B back to detector 102, as indicated generally at 124.

The difference between the on-axis image generated by detector 102 with illumination from first light source 108A and the off-axis image generated by detector 102 with illumination from second light source 108B highlights or emphasizes retroreflector 120. The difference between the images highlights retroreflector 120 because the reflection from retroreflector 120 is detected only in the on-axis image. The diffuse reflections from other environmental features are largely cancelled out, leaving retroreflector 120 as the dominant feature in the differential image. In one embodiment, the differential image is used to detect and/or track the position or location of retroreflector 120.

Differential reflectivity off retroreflector 120 is dependent upon angle 128 between first light source 108A and axis 132 of detector 102, and angle 130 between second light source 108B and axis 132 of detector 102. In general, a smaller angle 128 will increase the retroreflector return. As used herein, “retroreflector return” refers to the intensity (brightness) that is reflected off retroreflector 120 and detected by detector 102. Accordingly, angle 128 is selected such that first light source 108A is on or close to axis 132 of detector 102. In one embodiment, angle 128 is within a range of approximately 0-2 degrees. In general, the size of angle 130 is chosen so that only low or no retroreflector return from second light source 108B is detected at detector 102. In one embodiment, angle 130 is within a range of approximately 3-15 degrees. In other embodiments, the size of angles 128 and 130 are different than the above-specified sizes. In one form of the invention, the size of angles 128 and 130 is determined based on the characteristics of a particular retroreflector 120.

In one embodiment, light sources 108A and 108B emit light that provides substantially equal image intensity (brightness) as sensed by detector 102. In one embodiment, light sources 108A and 108B emit light of different wavelengths. The selected wavelengths are within a range in which detector 102 responds. In one embodiment, light sources 108A and 108B are implemented as LEDs or multimode lasers having infrared or near infrared wavelengths. In another embodiment, light sources 108A and 108B are implemented as LEDs or white lights having visible wavelengths. Each light source 108A and 108B is implemented as one or multiple light sources.

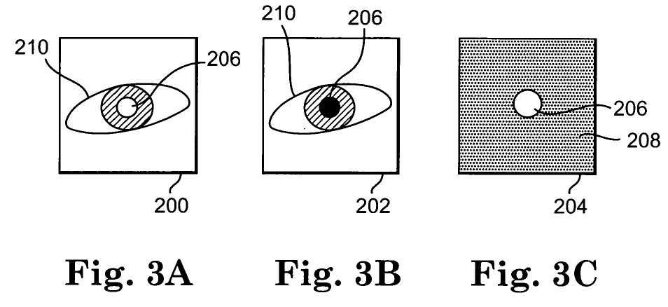

FIG. 3A illustrates one embodiment of an image 200 generated using on-axis illumination, such as the illumination provided by first light source 108A. Image 200 is generated using detector 102 and includes an eye 210 that is open. In one embodiment, eye 210 is retroreflector 120. Eye 210 has a bright pupil 206 due to a strong retinal return (retroreflector return) created by the illumination provided by the on-axis light source. If eye 210 had been closed, or nearly closed, bright pupil 206 would not be detected and imaged.

FIG. 3B illustrates one embodiment of an image 202 generated using off-axis illumination, such as the illumination provided by second light source 108B. Image 202 is generated at the same time as image 200 using detector 102. Image 202 includes an eye 210 with a normal, dark pupil 206. If eye 210 had been closed or nearly closed, the pupil 206 would not be detected and imaged.

FIG. 3C illustrates one embodiment of a difference image 204 resulting from the subtraction of image 202 generated using off-axis illumination from image 200 generated using on-axis illumination. By taking the difference between images 200 and 202, a relatively bright spot 206 remains against a relatively dark background 208 when eye 210 is opened. There may be vestiges of other features of eye 210 remaining in background 208. In general, however, bright spot 206 stands out in comparison to background 208. When eye 210 is closed or nearly closed, there will not be a bright spot 206 in differential image 204.

FIGS. 3A-3C illustrate one eye 210 of a subject. Both eyes of a subject can be monitored. It is understood that a similar effect is achieved if the images include other features of a subject (e.g., other facial features) as well as features of the subject's environment. These features largely cancel out in a manner similar to that just described, leaving either a bright spot 206 when the eye is open (or two bright spots, one for each eye) or no spot when the eye is closed or is nearly closed. It is understood that a similar result is achieved if a retroreflector 120 other than an eye 210 is detected and imaged. The number of spots will equal the number of retroreflectors 120 viewed.

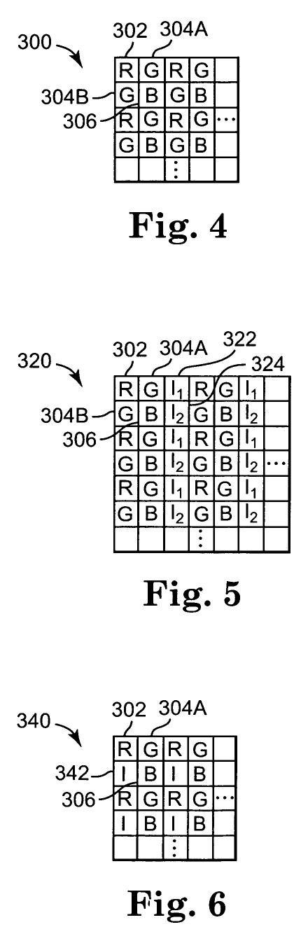

FIG. 4 is a diagram illustrating one embodiment of an image sensor 300 having a patterned filter layer. Image sensor 300 is incorporated into detector 102 and provides a pixel based method for simultaneously collecting the on-axis image and the off-axis image. To collect the on-axis image and the off-axis image simultaneously, light from a first light source, such as light source 108A, and light from a second light source, such as light source 108B, is separated by wavelength. First light source 108A provides on-axis illumination of a first wavelength, and second light source 108B provides off-axis illumination of a second wavelength. In wavelength separation, wavelength-selective filters are positioned in front of different groups of pixels in image sensor 300, so that the on-axis light is transmitted to a first group of pixels but not to a second group of pixels. Off-axis light is transmitted to the second group of pixels. In one embodiment, the filtering functions are interleaved on the surface of one imager. Microfilters or polarizers are formed on the surface of image sensor 300 in a suitable pattern to interleave the filtering function on the surface of image sensor 300.

In one form of the invention, a patterned filter layer is formed on image sensor 300 using three different types of filters according to the wavelengths being used by light sources 108A and 108B. In one embodiment, sensor 300 includes red light wavelength filters (R) 302, green light wavelength filters (G) 304A and 304B, and blue light wavelength filters (B) 306. The filters repeat in a two pixel by two pixel pattern over image sensor 300 to provide an RGGB image sensor 300. There are twice as many greens filters as red or blue filters in this embodiment because human perception of brightness depends most strongly on the green range. In this embodiment, image sensor 300 is a typical RGB image sensor for generating color images.

In this embodiment, image sensor 300 provides a first channel that is associated with the on-axis image and a second channel that is associated with the off-axis image. In other embodiments, the first channel is associated with the off-axis image and the second channel is associated with the on-axis image. In one embodiment, the patterned filter layer is deposited as a separate layer of sensor 300, such as, for example, on top of an underlying layer, using conventional deposition and photolithography processes while still in wafer form. In another embodiment, the patterned filter layer is created as a separate element between sensor 300 and incident light. In addition, the filter pattern can be configured in other suitable patterns. For example, the patterned filter layer can be formed into an interlaced striped or a non-symmetrical configuration (e.g., a three pixel by two pixel shape).

Various types of filter materials can be used in the patterned filter layer. In one embodiment, the filter materials include polymers doped with pigments or dyes. In other embodiments, the filter materials include interference filters, reflective filters, and absorbing filters made of semiconductors, other inorganic materials, or organic materials.

Referring back to FIG. 2, in one embodiment first light source 108A comprises a green light source and second light source 108B comprises red and blue light sources. The green light from first light source 108A is reflected from retroreflector 120 to provide a strong retroreflector return detected through green light wavelength filters 304A and 304B (the on-axis image), while the red and blue light from second light source 108B is detected through red light wavelength filters 302 and blue light wavelength filters 306 (the off-axis image). In addition, image sensor 300 generates an RGB image (the combination of the on-axis and off-axis images). Controller 106 (FIG. 1) generates the retroreflector 120 location data based on the difference between the on-axis image generated through green light wavelength filters 304A and 304B and the off-axis image generated through red light wavelength filters 302 and blue light wavelength filters 306. In another embodiment, second light source 108B comprises a white light source in place of the red and blue light sources to achieve a similar result.

FIG. 5 is a diagram illustrating another embodiment of an image sensor 320 having a patterned filter layer. Image sensor 320 includes red light wavelength filters 302, green light wavelength filters 304A and 304B, and blue light wavelength filters 306 as in image sensor 300, but adds a first infrared light wavelength filter (I₁) 322 and a second infrared light wavelength filter (I₂) 324 to provide an RGI₁/GBI₂ image sensor 320. The filter pattern repeats in a three pixel by two pixel pattern over image sensor 320. In one embodiment, image sensor 320 acts as an RGB image sensor for generating color images.

In this embodiment, image sensor 320 provides a first channel that is associated with the on-axis image and a second channel that is associated with the off-axis image. In other embodiments, the first channel is associated with the off-axis image and the second channel is associated with the on-axis image. In one embodiment, the patterned filter layer is deposited as a separate layer of image sensor 320, such as, for example, on top of an underlying layer, using conventional deposition and photolithography processes while still in wafer form. In another embodiment, the patterned filter layer is created as a separate element between sensor 320 and incident light. Various types of filter materials can be used in the patterned filter layer as previously described.

Referring back to FIG. 2, in one embodiment first light source 108A comprises a first infrared light source, and second light source 108B comprises a second infrared light source. The first infrared light from first light source 108A is reflected from retroreflector 120 to provide a strong retroreflector return detected through first infrared light wavelength filters 322 (the on-axis image), while the second infrared light from second light source 108B is detected through second infrared light wavelength filters 324 (the off-axis image). In addition, image sensor 320 generates an RGB image through red light wavelength filters 302, green light wavelength filters 304A and 304B, and blue light wavelength filters 306 using ambient illumination. Controller 106 generates the retroreflector 120 location data based on the difference between the on-axis image generated through first infrared light wavelength filters 322 and the off-axis image generated through second infrared light wavelength filters 324. In one embodiment, first light source 108A and/or second light source 108B includes red, green, and blue or white light sources in addition to the first or second infrared light source to provide illumination for RGB images.

FIG. 6 is a diagram illustrating another embodiment of an image sensor 340 having a patterned filter layer. Image sensor 340 is similar to image sensor 300, except green light wavelength filters 304B are replaced with infrared light wavelength filters (I) 342 to provide an RGIB image sensor 340. In one embodiment, image sensor 340 is similar to image sensor 300, except green light wavelength filters 304A are replaced with infrared light wavelength filters. The filter pattern repeats in a two pixel by two pixel pattern over image sensor 340. In one embodiment, image sensor 340 acts as an RGB image sensor for generating color images.

In this embodiment, image sensor 340 provides a first channel that is associated with the on-axis image and a second channel that is associated with the off-axis image. In other embodiments, the first channel is associated with the off-axis image and the second channel is associated with the on-axis image. In one embodiment, the patterned filter layer is deposited as a separate layer of sensor 340, such as, for example, on top of an underlying layer, using conventional deposition and photolithography processes while still in wafer form. In another embodiment, the patterned filter layer is created as a separate element between sensor 340 and incident light. Various types of filter materials can be used in the patterned filter layer as previously described.

Referring back to FIG. 2, in one embodiment first light source 108A comprises an infrared light source, and second light source 108B comprises a white light or red, green, and blue light sources. The infrared light from first light source 108A is reflected from retroreflector 120 to provide a strong retroreflector return detected through infrared light wavelength filters 342 (the on-axis image). The light from second light source 108B is detected through red light wavelength filters 302, green light wavelength filters 304A, and/or blue light wavelength filters 306 (the off-axis image). In this embodiment, the off-axis image is the RGB image. Controller 106 (FIG. 1) generates the retroreflector 120 location data based on the difference between the on-axis image generated through infrared light wavelength filters 342 and the off-axis image generated through red light wavelength filters 302, green light wavelength filters 304A, and blue light wavelength filters 306.

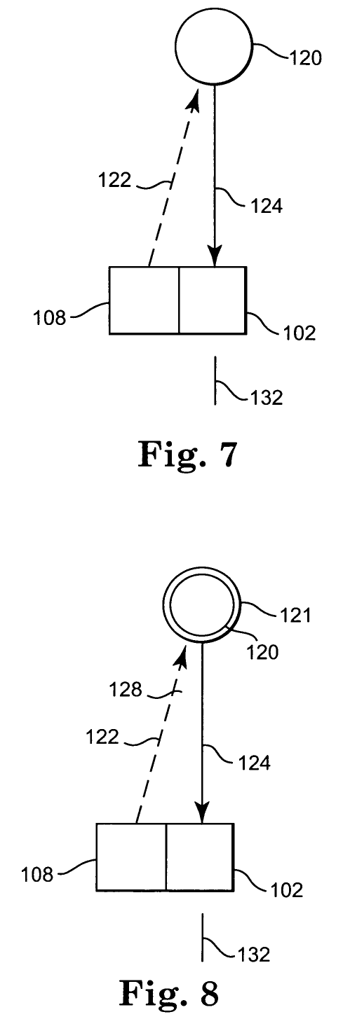

FIG. 7 is a block diagram illustrating another embodiment of imaging system 100 for detecting and/or locating a retroreflector 120. This embodiment operates in a similar manner as the embodiment illustrated in FIG. 2, except that in this embodiment only an on-axis light source 108 is used. Light source 108 is collocated with detector 102 close to or on axis 132 of detector 102 for generating on-axis images. In this embodiment, ambient light is used in place of second light source 108B to generate an equivalent off-axis image. The term “equivalent off-axis image,” as used herein, refers to an image generated without using an off-axis light source, such as second light source 108B, wherein the image includes data similar to data that would be generated in an off-axis image using an off-axis light source. The equivalent off-axis image is used in place of the off-axis image to locate a retroreflector by determining the difference between the equivalent off-axis image and the on-axis image.

In one embodiment, light source 108 includes a green light source for use with a detector 102 comprising an RGGB image sensor 300. A strong green retroreflector return through green light wavelength filters 304A and 304B provides the on-axis image, and the equivalent off-axis image is provided through red light wavelength filters 302 and blue light wavelength filters 306. Controller 106 (FIG. 1) generates the retroreflector 120 location data based on the difference between the on-axis image and the off-axis image. Controller 106 outputs retroreflector 120 location data and/or an RGB image, which is a combination of the on-axis image and equivalent off-axis image.

In another embodiment, light source 108 includes an infrared light source for use with a detector 102 comprising an RGIB image sensor 340. A strong infrared retroreflector return through infrared light wavelength filters 342 provides the on-axis image, and the equivalent off-axis image is provided through red light wavelength filters 302, green light wavelength filters 304A, and blue light wavelength filters 306. Controller 106 (FIG. 1) generates the retroreflector 120 location data based on the difference between the on-axis image and the off-axis image. Controller 106 outputs retroreflector 120 location data and/or an RGB image, which is the equivalent off-axis image.

FIG. 8 is a diagram illustrating another embodiment of imaging system 100 for detecting and/or locating a retroreflector 120. In this embodiment, retroreflector 120 includes a retroreflector filter 121. Retroreflector filter 121 is provided to pass light of a particular wavelength to retroreflector 120 while blocking light of all other wavelengths from retroreflector 120. By using retroreflector filter 121 in combination with retroreflector 120, only an on-axis light source 108 is used to provide illumination. An image having bright retroreflectors is generated at wavelengths emitted by on-axis light source 108 and transmitted through filter 121, since this light is strongly reflected by each and any retroreflector 120. An image having dark retroreflectors is generated at other wavelengths of light that are blocked by retroreflector filter 121. Ambient illumination will not generally result in bright retroreflectors because it comes from a location away from the image sensor. To prevent spurious scatter of ambient light off of features near the image sensor, it is good practice to make or paint features in this region, other than light source 108, dark at the wavelengths of interest. The patterned filter layer on image sensor 300 separates a subframe at the retroreflected wavelength band from one or more subframes at wavelengths with dark retroreflectors. Controller 106 (FIG. 1) generates the retroreflector 120 location data based on the difference between the image at the wavelength having bright retroreflectors and the image or images at wavelengths having dark retroreflectors.

In one embodiment, light source 108 provides a plurality of wavelengths of light including the wavelength of light passed by retroreflector filter 121 to retroreflector 120. In another embodiment, light source 108 provides only the wavelength of light passed by retroreflector filter 121 to retroreflector 120 to generate (together with ambient light) the retroreflected on-axis image, and ambient light is used for generating the image with bright retroreflectors at this wavelength. Ambient light alone is used for generating the image with dark retroreflectors as previously described with reference to FIG. 7.

In one embodiment, light source 108 includes a white light source or red, green, and blue light sources for use with an RGGB image sensor 300 and a green light wavelength retroreflector filter 121. In another embodiment, light source 108 includes a green light source and ambient light is used in place of the white light source or red, green, and blue light sources for use with the RGGB image sensor 300 and the green light-transmitting retroreflector filter 121. A strong green retroreflector return through green light wavelength filters 304A and 304B provides the retroreflected on-axis image with strong retroreflection, while the other image is provided through red light wavelength filters 302 and blue light wavelength filters 306. Controller 106 generates the retroreflector 120 location data based on the difference between the image with bright retroreflectors and the image with dark retroreflectors. Controller 106 outputs retroreflector 120 location data and/or an RGB image, which is the combination of the images through the R, G and B filters. In this case, in one embodiment, the green channel strength is reduced during subsequent image processing so that the strong green illumination does not unbalance the colors. In other embodiments, a red or blue light source is used in place of the green light source, and retroreflector filter 121 is a red or blue light wavelength filter.

In one embodiment, light source 108 includes a white light source or red, green, and blue light sources and a first infrared light source and a second infrared light source for use with an RGI₁/GBI₂ image sensor 320 and a first infrared light wavelength retroreflector filter 121. In another embodiment, light source 108 includes a first infrared light source and a second infrared light source and ambient light is used in place of the white light source or red, green, and blue light sources for use with the RGI₁/GBI₂ image sensor 320 and the first infrared light wavelength-selecting retroreflector filter 121. A strong first infrared light return through first infrared light wavelength filters 322 provides an image with bright retroreflectors, while retroreflector filter 121 blocks the second infrared wavelength to yield an image with dark retroreflectors through second infrared light wavelength filters 324. Controller 106 (FIG. 1) generates the retroreflector 120 location data based on the difference between the image with bright retroreflectors and the image with dark retroreflectors. Controller 106 outputs retroreflector 120 location data and/or an RGB image, which is generated through the red light wavelength filters 302, green light wavelength filters 304A and 304B, and blue light wavelength filters 306.

In one embodiment, light source 108 includes an infrared light source and a white light source or red, green, and blue light sources for use with an RGIB image sensor 340 and an infrared light wavelength-selecting retroreflector filter 121. In another embodiment, light source 108 includes an infrared light source and ambient light is used in place of the white light source or red, green, and blue light sources for use with the RGIB image sensor 340 and the infrared light wavelength-selecting retroreflector filter 121. A strong infrared light return through infrared light wavelength-selecting filters 342 provides the image with bright retroreflectors, and the image with dark retroreflectors is provided through red light wavelength filters 302, green light wavelength filters 304A, and blue light wavelength filters 306. Controller 106 (FIG. 1) generates the retroreflector 120 location data based on the difference between the image with bright retroreflectors and the image with dark retroreflectors. Controller 106 outputs retroreflector 120 location data and/or a human viewable image such as an RGB image, which is the image with dark retroreflectors.

In other embodiments, other suitable light source 108 and retroreflector filter 121 combinations are used to provide on-axis-illuminated images with bright retroreflectors and similar images with dark retroreflectors for detecting and/or locating retroreflectors. In one embodiment, a gain factor is applied to light that is transmitted through regions of filter material. The gain factor is used to balance the scene signals in one or more images and maximize the feature signals in one or more images.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An imaging system comprising:
an image sensor configured to generate an image of a field of view including a retroreflector;
a first light source on-axis with the image sensor, the first light source configured to illuminate the retroreflector; and
a controller configured to output the image and location data for the retroreflector.

2. The system of claim 1, wherein the controller is configured to determine the location data for the retroreflector based on a difference between a high intensity reflection from the retroreflector of light from the first light source and a low intensity reflection from the retroreflector of ambient light.

3. The system of claim 1, wherein the first light source provides light comprising at least one wavelength, and the retroreflector comprises a filter such that the retroreflector reflects the at least one wavelength.

4. The system of claim 1, wherein the first light source provides light comprising a first infrared light wavelength and a second infrared light wavelength, and wherein the first infrared light is blocked by a retroreflector filter and the second infrared light is reflected by the retroreflector.

5. The system of claim 1, wherein the image sensor comprises a red, green, green, blue (RGGB) light wavelength patterned filter.

6. The system of claim 1, wherein the image sensor comprises a red, green, infrared, blue (RGIB) light wavelength patterned filter.

7. The system of claim 1, wherein the image sensor comprises a red, green, first infrared, green, blue, second infrared (RGI₁/GBI₂) light wavelength patterned filter.

8. The system of claim 1, further comprising:
a second light source off-axis from the image sensor;
wherein the first light source provides light comprising a first wavelength and the second light source provides light comprising a second wavelength.

9. The system of claim 8, wherein the controller is configured to determine the location data for the retroreflector based on a difference between a high intensity reflection from the retroreflector of light from the first light source and a low intensity reflection from the retroreflector of light from the second light source.

10. The system of claim 8, wherein the first wavelength comprises a first visible light wavelength and the second wavelength comprises a second visible light wavelength.

11. The system of claim 10, wherein the first light source comprises a green light source.

12. The system of claim 8, wherein the first wavelength comprises a first infrared light wavelength and the second wavelength comprises a second infrared light wavelength.

13. The system of claim 8, wherein the first wavelength comprises an infrared light wavelength and the second wavelength comprises a visible light wavelength.

14. A retroreflector-tracking system comprising:
a retroreflector configured to reflect light having a first wavelength and block light having a second wavelength;
an image sensor configured to generate an image including a bright retroreflector and an image including a dark retroreflector;
a light source on-axis with the image sensor for providing light at the first wavelegth; and
a controller configured to provide location data for the retroreflector.

15. The system of claim 14, wherein the light source provides illumination at the second wavelength, and wherein the controller is configured to provide the location data based on a difference between the image including the bright retroreflector and the image including the dark retroreflector.

16. A method for generating a color image and the location of a retroreflector, the method comprising:
illuminating a retroreflector with a first light source on-axis with an image sensor;
generating a color image of a field of view of the image sensor including the retroreflector; and
analyzing the color image to determine the location of the retroreflector based on a reflection from the retroreflector.

17. The method of claim 16, wherein analyzing the image comprises determining the location of the retroreflector based on a difference between a high intensity reflection from the retroreflector of light from the first light source and a low intensity reflection from the retroreflector of ambient light.

18. The method of claim 16, further comprising;
illuminating the retroreflector with a second light source off-axis with the image sensor, the first light source providing light having a first wavelength and the second light source providing light having a second wavelength.

19. The method of claim 18, wherein analyzing the image comprises determining the location of the retroreflector based on a difference between a high intensity reflection from the retroreflector of light from the first light source and a low intensity reflection from the retroreflector of light from the second light source.

20. The method of claim 16, wherein illuminating the retroreflector with the first light source comprises illuminating the retroreflector with a first infrared light wavelength and a second infrared light wavelength source, wherein the first infrared light is blocked by a retroreflector filter and the second infrared light is reflected by the retroreflector.
